(19) United States
(12) Patent Application Publication
(10) Pub. No.: US 2025/0167923 A1
(43) Pub. Date: May 22, 2025

(54) Coordinated Transmission of Data by Multiple Access Points

(71) Applicant: Telefonaktiebolaget LM Ericsson (publ), Stockholm (SE)

(72) Inventors: Rocco Di Taranto, Lund (SE); Abhishek Ambede, Huddinge (SE); Leif Wilhelmsson, Lund (SE); Lakshmikanth Guntupalli, Lund (SE); Sebastian Max, Cologne (DE); János Farkas, Kecskemét (HU)

(21) Appl. No.: 18/839,205

(22) PCT Filed: Feb. 17, 2022
(86) PCT No.: PCT/EP2022/053889

§ 371 Date: Aug. 16, 2024

(51) Int. Cl. H04L 1/08; H04W 76/10

(52) U.S. Cl. CPC H04L 1/08; H04W 76/10

(57) ABSTRACT

An access point (10) of the wireless communication system coordinates sending of data on a wireless link. The wireless link is established between the access point (10) and a wireless device (11). Specifically, the access point (10) coordinates sending of the data by at least one of: a first wireless transmission performed by the access point (10), and a second wireless transmission performed on behalf of the access point (10) by a further access point (10) of the wireless communication system.

### TECHNICAL FIELD

The present invention relates to methods for controlling wireless transmissions and to corresponding devices, systems, and computer programs.

### BACKGROUND

Wireless communication technologies using unlicensed bands, like WLAN (Wireless Local Area Network) systems, also referred to as Wi-Fi systems, may be used in various kinds of applications and use cases. One of such use cases is data communication requiring high reliability and/or bounded latency, e.g., for applications in Industrial Internet of Things (IIoT). In such cases, a WLAN may be required to meet similar strict requirements as in wired networks based on time-sensitive networking (TSN) standards, e.g., as described in “Introduction to IEEE 802.1—Focus on the Time-Sensitive Networking Task Group” by J. Farkas (2017), available online under https://www.ieee802.org/1/files/public/docs2017/tsn -farkas-intro-0517-v01.pdf”. An example of such strict requirements is that packets are always transmitted “at the right time”, i.e., a transmitter should preferably be able to access the wireless channel with a delay or latency having a variation around a mean value, often denoted as jitter, that is guaranteed to be bounded. Another example of such strict requirements is high reliability, which means that the transmitted packets should be decoded correctly with very high probability at the receiver.

In a WLAN according to “IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 Standard”, the nature of the channel access rules and regulations for operations in license-exempt spectrum makes it rather difficult to provide deterministic channel access opportunities, unless the WLAN is operated in a spectrum controlled environment.

A technique already used for TSN in Ethernet, i.e., wire-based, context is the IEEE 802.1CB Frame Replication and Elimination for Reliability (FRER) scheme, as for example specified in IEEE 802.1CB Draft 2.9 (2017). The FRER scheme can substantially reduce the probability of packet loss due to equipment failures in an end-to-end communication scenario, hence increasing the probability of successful packet delivery as well. FRER relies on disjoint communication paths between two communicating nodes, thereby protecting against single points of failure. The FRER scheme operates by creating and eliminating multiple copies of frames either in end stations or in relay nodes such as bridges and routers. This may involve replication of frames for redundant transmissions, identification of duplicated frames, and elimination of such duplicated frames. The FRER scheme can also be applied in wireless communication systems, e.g., Wi-Fi 6 systems or 3GPP (3^{rd} Generation Partnership Project) Release 16 systems.

A possible way of utilizing the FRER scheme in a Wi-Fi system, is to replicate and duplicate packets on the same wireless channel: According to the IEEE 802.11-2020 Standard, section 10.3.2.14, to support duplicate frame detection, a Data, Management or Extension frame transmitted by a transmitter station (STA) includes a Retry subfield in the Frame Control Field and a Sequence Control field consisting of a sequence number and a fragment number. Duplicate frame detection can then be performed by a receiver STA by keeping track of the sequence numbers and fragment numbers of the frames in the current acknowledgement window that is received from each STA communicating with it. Thus, duplicated transmissions only happen within the acknowledgement window and in a sequential manner which is left to proprietary implementation. Also, duplicate frame detection can only be performed after successfully decoding a received physical layer protocol data unit (PPDU). Another possibility is to utilize parallel links as supported in the IEEE 802.11ax technology, see IEEE 802.11ax-2021—IEEE Standard for Information technology—Telecommunications and information exchange between systems Local and metropolitan area networks—Specific requirements Part 11: Wireless LAN Medium Access Control (MAC) and Physical Layer (PHY) Specifications Amendment 1: Enhancements for High Efficiency WLAN (19 May 2021), in the following denoted as “IEEE 802.11ax amendment” or “High Efficiency (HE) amendment”. In this case, FRER operation can be implemented in a manner which is transparent to the Wi-Fi system, which does not need to be aware of FRER stream splitting, sequencing, recovery functions, or the like.

An enhancement of the WLAN technology referred to as EHT (Extremely High Throughput), to be introduced with an amendment denoted as IEEE 802.11be, is planned to introduce a feature denoted as ML (multi-link). Corresponding functionalities are for example described in IEEE draft “IEEE P802.11be/D1.2”, September 2021, in the following denoted as EHT draft. In ML, a device termed as multi-link device (MLD) has multiple affiliated stations (STAs), each of which can communicate using independent wireless channels, also referred to as links. Communication over multiple links by an MLD is termed as multi-link operation (MLO). For example, an MLD can have two affiliated STAs, one communicating using a channel in the 5 GHz frequency band and the other communicating using a channel in the 6 GHz frequency band. Alternatively, as another example, an MLD can have two affiliated STAs, communicating using different channels in the 6 GHz frequency band. An AP MLD corresponds to an MLD with two or more affiliated AP STAs. A non-AP MLD corresponds to an MLD with two or more affiliated non-AP STAs. IEEE contribution “Wireless TSN in 802.11 and New Requirements for 802.11be and 802.1”, document IEEE 802.11-21/628r0, available online under https://mentor.ieee.org/802.11/dcn/21/11-21-0628-00-00be-wireless-tsn-in-802-11-and-new -requirements-for-802-11be-and-802-1.pptx (2021), discusses integration of the FRER scheme using MLDs in EHT.

When applied in a Wi-Fi network, the FRER scheme typically faces a single point of failure problem, adversely affecting availability and reliability, which in turn may result in not being able to support TSN use cases. This can easily be seen for single link devices. However, such limitation also applies for EHT MLD devices: Although EHT MLD may have the capability to communicate over multiple parallel links and possibly in different frequency bands, in case of hardware issues at the EHT MLD all links/channels would be affected in the same way. This is because typically all STAs affiliated with the same MLD are expected to be collocated. Moreover, using parallel links in the FRER scheme typically requires usage of one AP STA and one non-AP STA for each link, which may render implementation rather complex and may limit practical use to only few scenarios. Another limiting factor is the presence of strict association rules in the IEEE 802.11 Standard, according to which non-AP STAs can be associated with only one AP at a time. This implies that even if multiple links may be available between any pair of devices, the AP STA to which the non-AP STAs are associated, still constitutes a single point of failure.

Accordingly, there is a need for techniques which allow for efficiently improving reliability of communication in a wireless communication system.

### SUMMARY

According to an embodiment, a method of controlling wireless transmissions in a wireless communication system is provided. According to the method, an access point of the wireless communication system coordinates sending of data on a wireless link. The wireless link is established between the access point and a wireless device. Specifically, the access point coordinates sending of the data by at least one of: a first wireless transmission performed by the access point, and a second wireless transmission performed on behalf of the access point by a further access point of the wireless communication system.

According to an embodiment, a method of controlling wireless transmissions in a wireless communication system is provided. According to the method, an access point of the wireless communication system coordinates sending of data on a wireless link. The wireless link is established between a further access point of the wireless communication system and a wireless device. Specifically, the access point coordinates sending of the data by at least one of: a first wireless transmission performed by the further access point, and a second wireless transmission performed on behalf of the further access point by the access point.

According to an embodiment, a method of controlling wireless transmissions in a wireless communication system is provided. According to the method, a wireless device establishes a wireless link to an access point of the wireless communication system. Further, the wireless device receives data from the wireless link by least one of: a first wireless transmission performed by the access point, and a second wireless transmission performed on behalf of the access point by a further access point of the wireless communication system. The first wireless transmission and the second wireless transmission are coordinated on the wireless link.

According to a further embodiment, an access point for a wireless communication system is provided. The access point is configured to coordinate sending of data on a wireless link. The wireless link is established between the access point and a wireless device. Specifically, the access point is configured to coordinate sending of the data by at least one of: a first wireless transmission performed by the access point, and a second wireless transmission performed on behalf of the access point by a further access point of the wireless communication system.

According to a further embodiment, an access point for a wireless communication system is provided. The access point comprises at least one processor and a memory. The memory contains instructions executable by said at least one processor, whereby the access point is operative to coordinate sending of data on a wireless link. The wireless link is established between the access point and a wireless device. Specifically, the memory contains instructions executable by said at least one processor, whereby the access point is operative to coordinate sending of the data by at least one of: a first wireless transmission performed by the access point, and a second wireless transmission performed on behalf of the access point by a further access point of the wireless communication system.

According to a further embodiment, an access point for a wireless communication system is provided. The access point is configured to coordinate sending of data on a wireless link. The wireless link is established between a further access point of the wireless communication system and a wireless device. Specifically, the access point is configured to coordinate sending of the data by at least one of: a first wireless transmission performed by the further access point, and a second wireless transmission performed on behalf of the further access point by the access point.

According to a further embodiment, an access point for a wireless communication system is provided. The access point comprises at least one processor and a memory. The memory contains instructions executable by said at least one processor, whereby the access point is operative to coordinate sending of data on a wireless link. The wireless link is established between a further access point of the wireless communication system and a wireless device. Specifically, the memory contains instructions executable by said at least one processor, whereby the access point is operative to coordinate sending of the data by at least one of: a first wireless transmission performed by the further access point, and a second wireless transmission performed on behalf of the further access point by the access point.

According to a further embodiment, a wireless communication device for a wireless communication system is provided. The wireless communication device is configured to establish a wireless link to an access point of the wireless communication system. Further, the wireless device is configured to receive data from the wireless link by least one of: a first wireless transmission performed by the access point, and a second wireless transmission performed on behalf of the access point by a further access point of the wireless communication system. The first wireless transmission and the second wireless transmission are coordinated on the wireless link.

According to a further embodiment, a wireless communication device for a wireless communication system is provided. The wireless communication device comprises at least one processor and a memory. The memory contains instructions executable by said at least one processor, whereby the wireless communication device is operative to establish a wireless link to an access point of the wireless communication system. Further, the memory contains instructions executable by said at least one processor, whereby the wireless communication device is operative to receive data from the wireless link by least one of: a first wireless transmission performed by the access point, and a second wireless transmission performed on behalf of the access point by a further access point of the wireless communication system.

The first wireless transmission and the second wireless transmission are coordinated on the wireless link.

According to a further embodiment, a computer program or computer program product is provided, e.g., in the form of a non-transitory storage medium, which comprises program code to be executed by at least one processor of an access point of a wireless communication system. Execution of the program code causes the access point to coordinate sending of data on a wireless link. The wireless link is established between the access point and a wireless device. Specifically, execution of the program code causes the access point to coordinate sending of the data by at least one of: a first wireless transmission performed by the access point, and a second wireless transmission performed on behalf of the access point by a further access point of the wireless communication system.

According to a further embodiment, a computer program or computer program product is provided, e.g., in the form of a non-transitory storage medium, which comprises program code to be executed by at least one processor of an access point of a wireless communication system. Execution of the program code causes the access point to coordinate sending of data on a wireless link. The wireless link is established between a further access point of the wireless communication system and a wireless device. Specifically, execution of the program code causes the access point to coordinate sending of the data by at least one of: a first wireless transmission performed by the further access point, and a second wireless transmission performed on behalf of the further access point by the access point.

According to a further embodiment, a computer program or computer program product is provided, e.g., in the form of a non-transitory storage medium, which comprises program code to be executed by at least one processor of a wireless device. Execution of the program code causes the wireless device to establish a wireless link to an access point of the wireless communication system. Further, execution of the program code causes the wireless device to receive data from the wireless link by least one of: a first wireless transmission performed by the access point, and a second wireless transmission performed on behalf of the access point by a further access point of the wireless communication system. The first wireless transmission and the second wireless transmission are coordinated on the wireless link.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2A schematically illustrates an example of a scenario involving coordinated serving of a wireless link by multiple access points according to an embodiment.

FIG. 2B schematically illustrates a further example of a scenario coordinated serving of a wireless link by multiple access points according to an embodiment.

FIG. 3 illustrates an example of channel usage in coordinated serving of a wireless link by multiple access points according to an embodiment.

FIG. 4A shows an example of signaling in coordinated serving of a wireless link by multiple access points according to an embodiment.

FIG. 4B shows a further example of signaling in coordinated serving of a wireless link by multiple access points according to an embodiment.

FIG. 5 shows a flowchart for schematically illustrating a method according to an embodiment.

FIG. 6 shows a block diagram for schematically illustrating functionalities of an access point according to an embodiment.

FIG. 7 shows a flowchart for schematically illustrating a further method according to an embodiment.

FIG. 8 shows a block diagram for schematically illustrating functionalities of a further access point according to an embodiment.

FIG. 9 shows a flowchart for schematically illustrating a further method according to an embodiment.

FIG. 10 shows a block diagram for schematically illustrating functionalities of a wireless device according to an embodiment.

FIG. 11 schematically illustrates structures of an access point according to an embodiment.

FIG. 12 schematically illustrates structures of a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

According to the illustrated concepts, multiple access points (APs) of the wireless communication system can cooperate on the same wireless link. The wireless link is established between a wireless device and an AP to which the wireless device is associated. The wireless device can for example be a non-AP STA. In the following, the wireless device will also be denoted as “station” or “STA”. The AP to which the wireless link is established is in the following denoted as the “connected AP”. It is noted that the connected AP and the non-connected AP may be located at different positions. The wireless link should thus not be understood in a geometric sense, e.g., as corresponding to a spatial channel between the connected AP and the STA, but rather as being based on a logical association of the STA and the connected AP. On a logical level, the wireless link may be defined based its endpoints, e.g., by a device address of the STA and a device address of the connected AP. Such device addresses may in particular correspond to MAC addresses. However, other types of device identifiers could be used as well. One or more other APs which cooperate with the connected AP in transmitting on the wireless link are denoted as “non-connected AP”. In the illustrated concepts, the STA may receive data through a downlink wireless transmission on the wireless link. In some cases, the downlink wireless transmission may be performed by the connected AP. In other cases, the downlink wireless transmission may be performed by a non-connected AP, however on behalf of the connected AP. This may for example involve that the non-connected AP used the device address of the connected AP when sending the downlink wireless transmissions. From the perspective of the STA, the received downlink wireless transmission may thus appear as coming from the connected AP, even if it was sent by the non-connected AP. The illustrated concepts may be applied for efficiently complying with high reliability requirements of data transmissions. In particular, when sending data on the wireless link, the connected AP may coordinate a further downlink wireless transmission of the same data on the wireless link. The further downlink wireless transmission is performed by the non-connected AP, on behalf of the connected AP. The data may thus be sent in a redundant manner, thereby enhancing the reliability of successful reception at the STA. In some cases, the connected AP may also coordinate with the non-connected AP to decide between either sending the data in a downlink wireless transmission performed by the connected AP, alternatively sending the data in a further downlink wireless transmission performed by the non-connected AP on behalf of the connected AP, or sending the data in a redundant manner in both a downlink wireless transmission performed by the connected AP and a further downlink wireless transmission performed by the non-connected AP on behalf of the connected AP. The decision whether to send the data alternatively in the downlink transmission from the connected AP or in the downlink transmission from the non-connected AP could aim at sending the data by that AP which is expected to provide better channel quality, which again may contribute to enhanced reliability. The coordination of the downlink wireless transmissions from the different APs on the wireless link may involve assigning the downlink wireless transmission(s) from the non-connected AP(s) to radio resources which are distinct from radio resources used for the downlink wireless transmission from the connected AP. The coordination may be based on coordination mechanisms, e.g., like coordination by DCM (Dual Carrier Modulation), OFDMA (Orthogonal Frequency Division Multiple Access), or TDMA (Time Division Multiple Access). In the case of DCM, OFDMA, the connected AP and the non-connected AP use different frequency resources for performing the respective downlink transmission, e.g., different subcarriers and/or different resource units (RUs). In the case of TDMA, the connected AP and the non-connected AP use different time resources for performing the respective downlink transmission, e.g., different time slots. The coordination may be based on various kinds of connectivity between the connected AP and the non-connected AP, e.g., wireless connectivity, wire-based connectivity, or connectivity through a common network controller. Such network controller may in turn be connected by wireless connectivity and/or wire-based connectivity to the APs.

When using the illustrated concepts in redundant transmission of data by the connected AP and one or more non-connected APs, single point of failure problems can be avoided while complying with strict association rules of Wi-Fi technologies, according to which a STA can be associated to only one AP at a time. However, the possibility to receive data from a non-connected AP may also be useful in other scenarios, such as in cases where the channel conditions with respect to the connected AP are variable. In such cases, the data may alternatively or in addition be transmitted by one or more non-connected APs, without requiring that the STA re-associates to another AP. As a result, connection continuity can be improved.

The variable channel conditions may for example be due movement of the STA or shadowing effects, e.g., when a person, robot, or some other obstacle passes between the non-AP STA and the connected AP.

In some scenarios, multiple APs may be available to be used as non-connected APs. In such cases, the illustrated concepts may also provide a mechanism for selecting a set of one or more non-connected APs to cooperate in the downlink transmissions on the wireless link between the connected AP and the STA. Such selection mechanism may for example be based on measurements reported from the STA to the connected AP. The APs that cooperate in the downlink transmissions on the wireless link between the connected AP may also mutually assist each other as non-connected APs. For example, a first STA can have a wireless link to a first AP, while a second STA has a wireless link to a second AP. In this scenario, the first AP would be the connected AP of the first STA, and the second AP would be the connected AP of the second STA. The second AP could act as non-connected AP for the first STA, by performing downlink transmissions on behalf of the first AP to the first STA, while the first AP could act as non-connected AP for the second STA, by performing downlink transmissions on behalf of the second AP to the second STA. In such scenarios, it may be beneficial to coordinate the APs in such a way that they operate on different primary subchannels.

Further, it is noted that, while the illustrated concepts involve that the STA may receive downlink transmissions from multiple APs, advanced capabilities like multi-link operation are not required in the STA, because the downlink transmissions from the different APs are coordinated on the same wireless link.

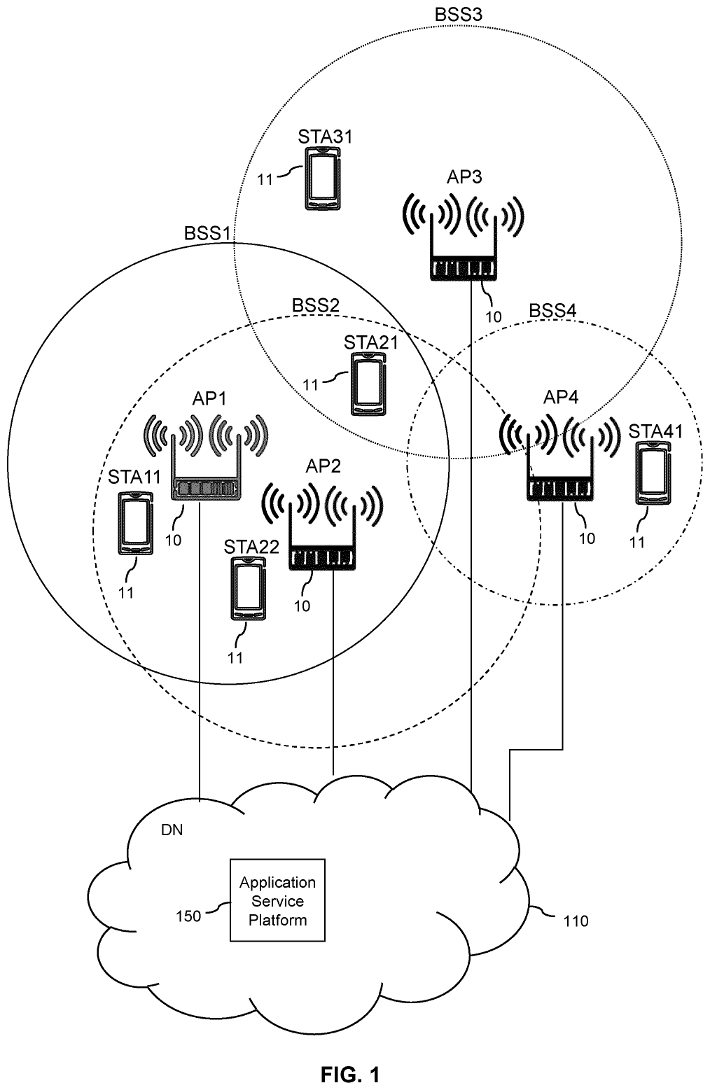

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA12, STA21, STA22, STA31, and STA41. STA11 and STA 12 are served by AP1 (in a first BSS denoted as BSS1), STA21 and STA22 are served by AP2 (in a second BSS denoted as BSS2), STA31 is served by AP3 (in a third BSS denoted as BSS3), and STA41 is served by AP4 (in a fourth BSS denoted as BSS4). The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed or license-exempt band like the 2.4 GHz ISM band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 1 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

In the illustrated concepts, one or more of the stations 11 can benefit from the possibility of receiving data not only by downlink wireless transmissions from the respective connected AP 10, but additionally or alternatively also by downlink wireless transmissions from one or more non-connected APs 10. By way of example, for STA11 the connected AP is AP1. In the illustrated concepts, AP1 could coordinate with AP2, so that AP2 can also transmit data as non-connected AP to STA11. Similarly, for STA21 the connected AP is AP2. In the illustrated concepts, AP2 could coordinate with AP1, so that AP1 can also transmit data as non-connected AP to STA21. Here, it is beneficial that BSS1 and BSS2 are overlapping, with so that STA11 and STA21 are located both in coverage of BSS1 and in coverage of BSS2. Such ovelarlap of BSSs is for example often present in IIoT scenarios with many APs deployed in close proximities.

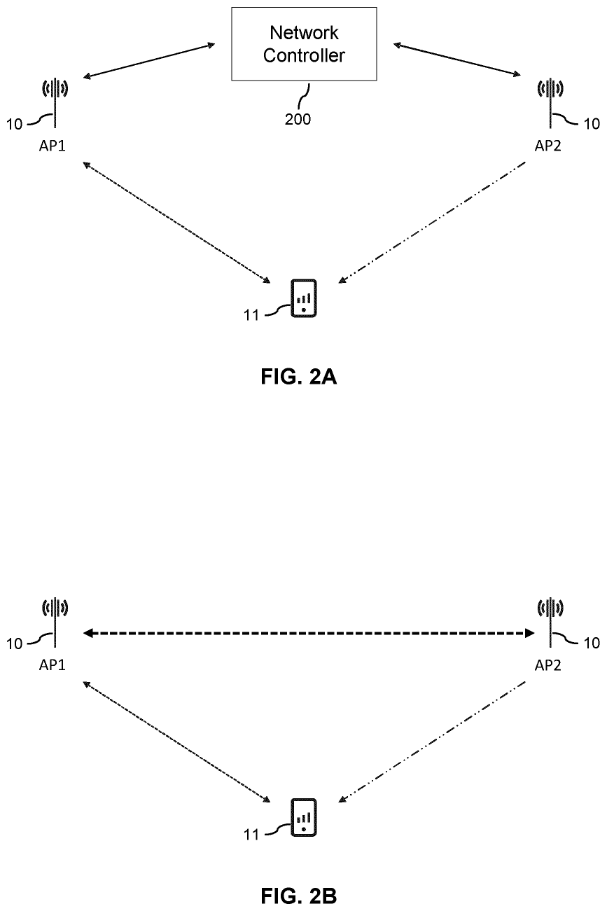

As mentioned above, the coordination of the connected AP and the non-connected AP(s) may be based on connectivity of both APs to a common network controller. FIG. 2A illustrates an example of a corresponding scenario. In the example of FIG. 2A, a station 11 is associated to a first AP 10, denoted as AP1, but also in coverage of a second AP, denoted as AP2. For example, these APs 10 could correspond to AP1 and AP2 in the example of FIG. 1, and the station 11 could correspond to STA11 or STA21. In the example of FIG. 2A, AP1 is the connected AP of the station 11, while AP2 serves as a non-connected AP. AP1 and AP2 are both connected to network controller 200, e.g., by wire-based connections. However, it is noted that it would also be possible that at least one of AP1 and AP2 is connected by a wireless connection to the network controller 200.

Using wired-based connectivity between the APs 10, potentially through a network controller as illustrated in FIG. 2A, may enable an always-on connection between the APs 10. Each AP 10 can independently follow a listen-before-talk (LBT) procedure to access the wireless channel. If in the example of FIG. 2A the connected AP needs to send data to the station 11, it can immediately request assistance from AP2, without requiring access to the wireless channel to coordinate with AP2. Then, when AP1 gains access to the wireless channel, the wire-based connectivity between the APs 10 may be used to schedule the coordinated downlink transmissions by both APs. Further, the wire-based connectivity may be used to signal the data to be transmitted from AP1 to AP2. It is however noted that wire-based connectivity between the APs may require proprietary signaling above the MAC (Medium Access Control) layer. Further, additional cabling may be required.

FIG. 2B illustrates an example of a scenario where the coordination of the connected AP and the non-connected AP(s) is based on wireless connectivity between the APs. Such scenario may also be referred to as OTA (Over-the-Air) coordination. In the example of FIG. 2B, a station 11 is associated to a first AP 10, denoted as AP1, but also in coverage of a second AP, denoted as AP2. For example, these APs 10 could correspond to AP1 and AP2 in the example of FIG. 1, and the station 11 could correspond to STA11 or STA21. In the example of FIG. 2A, AP1 is the connected AP of the station 11, while AP2 serves as a non-connected AP. AP1 and AP2 are located in each other's wireless coverage, so that AP2 can receive wireless transmissions from AP1 and vice versa.

Wireless connectivity between the cooperating APs has the benefit of a relatively low complexity implementation, e.g., by avoiding a need for additional cabling between APs. However, the wireless connectivity requires an availability of a wireless channel for signaling between the cooperating APs. This can be the same wireless channel which is also used for wireless communication between the APs and their respective associated STAs. In Wi-Fi technologies, and also in many other technologies using a shared wireless channel, the wireless channel needs to be accessed based on an LBT (Listen-Before-Talk) mechanism, which might result in situations where the wireless channel is not available for coordination signaling between the APs. In the illustrated concepts, the coordination signaling on the wireless channel may at the same time be used to reserve a TXOP (Transmission Opportunity) on the wireless channel, to be used for the coordinated downlink wireless transmissions by the connected AP and the non-connected AP(s).

As mentioned above, the coordinated transmissions by the connected AP and the non-connected AP(s) can be based on DCM. The basic principle of DCM is to send the same information on multiple, in particular a pair of subcarriers, to allow for soft combining gains during reception. In the illustrated concepts, DCM may for example be utilized in accordance with the optional DCM modulation scheme specified in the IEEE 802.11ax amendment. The DCM may be implemented as distributed DCM, i.e., a transmission where multiple APs, e.g., AP1 and AP2, transmit in a time synchronized manner using subcarriers which are alternatingly distributed over the available bandwidth of the wireless channel. In such distributed DCM, adjacent subcarriers would thus be utilized by different APs. The STA is typically informed about the utilized DCM scheme. Further, the STA could also be informed that the DCM transmission is performed by multiple APs. It is however noted that the latter information is not necessarily required and could also be omitted. As a result of utilizing DCM, the STA receives multiple copies of same signal, which typically experience different channel conditions on the path from the respective AP. Even if one of the paths suffers from poor channel conditions, successful reception may still be possible by considering the multiple copies of the received signal.

When sending the coordinated downlink transmissions, the APs may apply the same MCS (Modulation and Coding Scheme). The STA can then combine the received copies of the signal to improve the reception. For this purpose, the STA may for example apply DCM reception functionalities as specified for the IEEE 802.11ax amendment.

Alternatively, the APs could also apply different MCSs when sending the coordinated downlink transmissions. For example, one of the cooperating APs could apply a higher order MCS and send more information or more copies of the same information than another one of the cooperating APs. In such cases, the STA may be informed about such utilization of different MCSs, so that the STA can adapt its decoding processes accordingly. The STA may then separately decode the information from the subcarriers corresponding to a certain MCS.

The DCM utilized for the coordinated downlink transmissions could also be based on a flavor of DCM as specified in the EHT draft, denoted as “DCM+DUP”, where DUP stands for “duplicated”. In the case of DCM+DUP, DCM is supplemented by replicating the same data over two halves of the reserved transmission bandwidth. For example, in the scenario of FIG. 2A or 2B, AP1 and AP2 can perform concurrent downlink transmissions based on DCM+DUP to the station 11, with the subcarriers being alternately assigned to AP1 and AP2, and the same data could be replicated over two halves of the reserved transmission bandwidth. In this way, reliability can be further enhanced by means of added frequency diversity. In some cases, the APs may leave additional gaps between the subcarriers assigned to different APs, which may for example help to avoid problems due to imbalances in received signal power between the signals from the different APs.

As mentioned above, in some scenarios the coordinated transmissions by the connected AP and the non-connected AP(s) could also be based on OFDMA. In the case of OFDMA, different groups of frequency subcarriers, typically denoted as RUs, are independently modulated by the respective AP. The OFDMA-based transmissions may for example be based on OFDMA functionalities as specified in the IEEE 802.11ax amendment. In the coordinated downlink transmissions, the non-connected AP transmits on another RU than the connected AP, but mimics the connected AP, e.g., by using the same preamble portion as the connected AP. When for example considering a scenario like in the examples of FIG. 2A or 2B, AP1 may use a first set of one or more RUs when performing its downlink transmissions to the station 11, while AP2 uses a non-overlapping second set of one or more RUs when performing its downlink transmission to the station 11. The station 11 is informed about the OFDMA scheme utilized by AP1 and AP2 and that the first set of one or more RUs and the second set of one or more RUs carry the same data. It is however noted that the station 11 does not need to be aware that the coordinated downlink transmissions come from different APs. Rather, from the perspective of the station 11, the two downlink transmissions may appear as coming from the connected AP, i.e., from AP1. The non-connected AP, i.e., AP2 in the example of FIG. 2A or 2B, may mimic the connected AP, i.e., AP1, e.g., by replicating the preamble field used by the connected AP. In some scenarios, it can however be useful to also inform the station 11 that the first set of one or more RUs and the second set of one or more RUs carry downlink transmissions from different APs.

In some cases, the connected AP and the non-connected AP(s) may use the same MCS and same size RUs when performing the downlink transmissions coordinated by OFDMA. In such cases, the STA receiving the coordinated downlink transmission may apply soft combining of the signals from the different AP(s). To enable such soft combining, the STA may be informed that two sets of RUs of the same size carry the same data, which is encoded with identical MCSs.

In other cases, the connected AP and the non-connected AP(s) may use the different MCSs and/or different size RUs when performing the downlink transmissions coordinated by OFDMA. In such cases, the STA may be informed about the different MCSs and/or the different RU sizes and utilize this information when decoding the redundant data from the RUs. For this purpose, the STA may separately process the signals received in different RUs. For example, if in the example of FIG. 2A or 2B AP1 transmits on RU1 using a first MCS and AP2 transmits on RU2 using a second MCS, with RU1 and RU2 having different sizes and/or the first MCS being different from the second MCS, the station 11 may perform separate receiver processing for RU1 and RU2. In some cases, the APs may leave additional gaps between the RUs assigned to different APs, which may for example help to avoid problems due to imbalances in received signal power between the signals from the different APs.

As mentioned above, in some scenarios the coordinated transmissions by the connected AP and the non-connected AP(s) could also be based on TDMA. In the case of TDMA, the connected AP and the non-connected AP(s) utilize different time resources, typically referred to as slots, when performing the coordinated downlink transmissions to the STA. When for example considering the scenario of FIG. 2A or 2B, AP1 may send a downlink transmission with data in a first time slot to the station 11, and AP2 may send a further downlink transmission with the same data in a second time slot. The station 11 may be informed about the TDMA scheme applied by the APs, in particular that the first time slot and the second time slot will carry the same data. It is however noted that the station 11 does not need to be aware that the downlink transmissions in the first and second time slots come from different APs. Rather, from the perspective of the station 11, the two downlink transmissions may appear as coming from the connected AP, i.e., from AP1. The non-connected AP, i.e., AP2 in the example of FIG. 2A or 2B, may mimic the connected AP, i.e., AP1, e.g., by replicating the preamble field used by the connected AP. In some scenarios, it can however be useful to also inform the station 11 that the first time slot and the second time slot carry downlink transmissions from different APs.

In some cases, the coordinated downlink transmissions from the connected AP and the non-connected AP(s) may be based on the same transmit parameters, e.g., use the same MCS, same RU allocation, and the same bandwidth. If the STA can successfully decode the first downlink transmission, the STA can ignore or discard the subsequent second downlink transmission. If the decoding of the first downlink transmission alone is not successful, the STA may apply soft combining with the subsequent second downlink transmission to still achieve successful decoding of the data. Accordingly, even if the data cannot be successfully decoded from the first downlink transmission, the STA can leverage that there will be another downlink transmission of the same data.

In some cases, the coordinated downlink transmissions from the connected AP and the non-connected AP(s) may be based on the different transmit parameters, e.g., use the different MCS, different RU allocation, or different bandwidth. This may result in that one of the APs needs more time for its downlink transmission. By allowing utilization of different transmit parameters, each AP may optimize its respective downlink transmission in view of the individually applicable channel conditions with respect to the STA. For example, if in the scenario of FIG. 2A or 2B it is estimated that the downlink transmission from AP1 would be received at the station 11 with a higher SNR than the downlink transmission from AP2, AP1 could use a higher data-rate MCS for its downlink transmission. It is however noted that when allowing utilization of different transmit parameters by the APs, simple soft combining of the received downlink transmissions may no longer be possible. Rather, the STA may need to perform separate receiver processing for the subsequently received downlink transmissions.

The coordination of the downlink transmissions by TDMA may have the benefit that frequency synchronization of the connected AP and the non-connected AP(s) is not needed and, consequently, problems associated with improper frequency synchronization of the APs can thus be avoided.

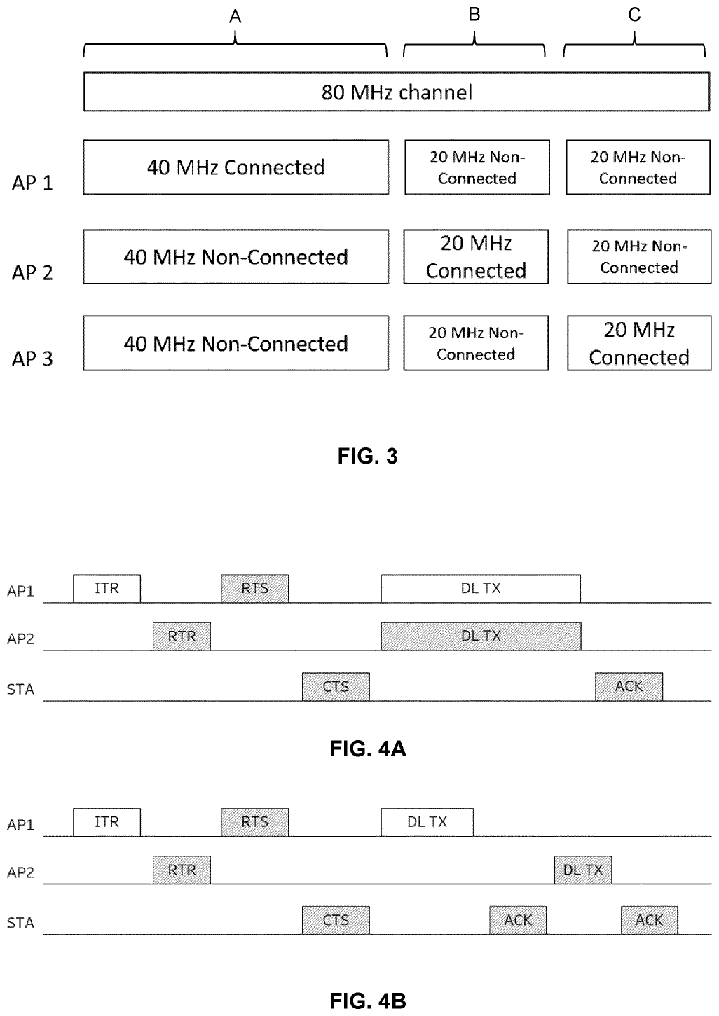

As can be seen from the above explanations, the illustrated concepts can be implemented with two cooperating APs, i.e., a connected AP and a non-connected AP, but also with more APs, i.e., a connected AP and two or more non-connected APs. Further, it is noted that the role of connected AP and non-connected AP is defined from the perspective of a certain STA. Accordingly, the same AP could act as the connected AP of a certain STA and as a non-connected AP of another STA. In such case, the APs may also mutually assist each other. In such cases, multiple APs may be coordinated, with each AP operating as a connected AP on a respective primary wireless channel, and as a non-connected AP on a secondary wireless channel. FIG. 3 illustrates a corresponding example of allocating different parts of the available bandwidth of the wireless channel among three APs, denoted as AP1, AP2, and AP3, which each act as both connected AP and non-connected AP. These APs and their respectively associated STAs may for example correspond to the correspondingly designated APs 10 and stations 11 of FIG. 1.

In the example of FIG. 3, there are thus three BSSs, each having a single connected AP with one or more associated STAs, with the BSS of AP1 being denoted as BSS1, the BSS of AP2 being denoted as BSS2, and the BSS of AP3 being denoted as BSS3. In order to enhance the reliability for the associated STAs in each of the three BSSs, the respective other APs may act as non-connected APs for these APs. In the example of FIG. 3, there is thus no need for an extra AP to act as non-connected AP.

In the example of FIG. 3, it is assumed that the coordination of the downlink transmissions is based on OFDMA over a bandwidth of 80 MHz. The allocation of the bandwidth to the APs is as follows: The overall bandwidth can be regarded as being divided into three portions, denoted as A, B, and C, corresponding to the respective primary (connected) bandwidth of the APs. The bandwidth portion A extends over the first 40 MHz, the bandwidth portion B extends over the next 20 MHz, and the bandwidth portion C extends over the remaining 20 MHz. AP1 uses the bandwidth portion A as its primary (or connected) bandwidth and the bandwidth portions B and C as secondary (or non-connected) bandwidth. The secondary bandwidth of AP1 is subdivided so that the bandwidth portion B is used for assisting downlink transmissions to AP2 and the bandwidth portion C is used for assisting downlink transmissions to AP3. The one or more STAs associated with AP1 operate in the primary bandwidth of AP1, i.e., bandwidth portion A. AP2 uses the bandwidth portion B as its primary (or connected) bandwidth and the bandwidth portions A and C as secondary (or non-connected) bandwidth. The secondary bandwidth of AP2 is subdivided so that the bandwidth portion A is used for assisting downlink transmissions to AP1 and the bandwidth portion C is used for assisting downlink transmissions to AP3. The one or more STAs associated with AP2 operate in the primary bandwidth of AP2, i.e., bandwidth portion B. AP3 uses the bandwidth portion C as its primary (or connected) bandwidth and the bandwidth portions A and B as secondary (or non-connected) bandwidth. The secondary bandwidth of AP3 is subdivided so that the bandwidth portion A is used for assisting downlink transmissions to AP1 and the bandwidth portion B is used for assisting downlink transmissions to AP2. The one or more STAs associated with AP3 operate in the primary bandwidth of AP3, i.e., bandwidth portion C.

Based on the bandwidth allocation as illustrated in FIG. 3, all three BSSs may benefit from increased reliability. For each of the BSSs, the coordination of the downlink transmissions from the connected AP and the non-connected APs may be performed in an independent manner. For example, in BSS1, the downlink transmissions in the bandwidth portion A can be coordinated in such a way that three redundant downlink transmissions carrying the same data are sent from AP1 (as connected AP), AP2 (as non-connected AP), and AP3 (as non-connected AP). These redundant downlink transmissions may each use about ⅓ of the bandwidth portion A. Alternatively, AP1 could send two redundant downlink transmissions of the same data in one half of the bandwidth portion A, with each redundant downlink transmission thus occupying 10 MHz bandwidth, while AP2 and AP3 send two further redundant downlink transmissions in the other half of the bandwidth portion A, again with each redundant downlink transmission occupying 10 MHz bandwidth. The redundant downlink transmissions from the connected AP and the non-connected APs may thus be coordinated to use different frequency resources. Alternatively, the coordination of downlink transmissions from the connected AP and the non-connected APs within the BSS could also be based on a TDMA scheme. As mentioned above, the redundant downlink transmissions may then be performed on different time resources, e.g., in different time slots.

It is noted that in the above examples, a certain STA may have the possibility of choosing the AP to which it associates, i.e., the connected AP. Such selection may for example be based on the conditions experienced on the respective primary channel of the APs.

Further, in some scenarios there may be a need to perform selection of the one or more non-connected APs. For example, if there are multiple other APs in the vicinity of the connected AP, the connected AP may select which of these APs to use as non-connected AP for the STAs associated with the connected AP. This may also include the case that whether a specific AP should cooperate as non-connected AP with a first other AP or a second other AP. Such selection may for example be based on demands of the respective connected AP. For example, the connected AP having a higher demand of high-reliability traffic may be preferred in being allowed to select one or more other APs to cooperate as non-connected AP. Further, such selection may be based on measurements reported by the associated STAs. For example, if the STAs associated with a certain AP report higher received signal strength from a first other AP than from a second other AP, the first other AP may be preferred in selecting the AP for cooperation as a non-connected AP.

In some scenarios, the non-connected AP(s) may be thus be selected in a dynamic manner, and such selection may be based on reports from one or more STAs. For obtaining such reports, the APs could for example utilize measurement and reporting functionalities as specified in the IEEE 802.11 Standard, e.g., in Section 11.10. For example, such functionalities could be used by the connected AP to acquire information which other APs an associated STA can hear, e.g., by requesting for Beacon reports. The selection of one or more non-connected APs may then be based on the reported information, e.g., by selecting an AP which can be heard by a majority of the associated STAs or by selecting an AP with high reported received signal strength at the associated STA.

The coordination of the downlink transmissions from the connected AP and the non-connected AP(s) may be based on various kinds of signaling. For example, such signaling may be used between the connected AP and its associated STA(s) and/or between the connected AP and the non-connected AP(s). FIG. 4A illustrates an example of signaling which may be used in the case of coordination by DCM, DCM+DUP, or OFDMA. FIG. 4B illustrates an example of signaling which may be used in the case of coordination by TDMA.

In the example of FIG. 4A, it is assumed that AP1 gains access to the wireless channel and reserves a TXOP which it intends to use for coordinated downlink transmissions from AP1 and AP2 to a STA, which is associated with AP1. AP1 thus sends an ITR (Invitation-To-Replicate) frame to AP2. If AP2 is willing to participate in the cooperation, AP2 sends an RTR (Ready-to-Replicate) frame to AP1. Then an RTS (Ready to Send)/CTS (Clear to Send) frame exchange is performed between AP1 and the STA. After the RTS/CTS frame exchange, both AP1 and AP2 send a downlink transmission (DL TX) carrying the same data to the STA. These downlink transmissions are performed in a concurrent manner, however using different frequency resources. Upon successfully receiving at least one of these redundant downlink transmissions, the STA sends an acknowledgement (ACK) to confirm successful reception. The acknowledgement may be sent to AP1 and/or to AP2.

The ITR frame may include, an indication of a selected multi-AP coordination mode, e.g., an indication of coordination by OFDMA, an indication of coordination by DCM, or an indication of coordination by DCM+DUP. Further, the ITR frame may indicate a resource allocation for AP1 and AP2, e.g., in terms of one or more RUs allocated to AP1 and one or more RUs allocated to AP2, or in terms of a group of subcarriers allocated to AP1 and a group of subcarriers allocated to AP2. Further, the ITR frame may indicate a length of the intended downlink transmissions, e.g., terms of a length of PPDU (Physical Packet Data Unit) to be transmitted.

The RTS frame from AP1 may inform the STA that the upcoming downlink transmissions includes a replica of the same signal on different frequency resources, e.g., on different RUs when using OFDMA or on different subcarrier groups when using DCM or DCM+DUP. Here, it is noted that the STA typically does not need to be informed that the replicas come from different APs. Further, the ITR frame, the RTR frame, the RTS frame, and the CTS frame may be used to protect the wireless channel from interference, by indicating to other devices that the wireless channel is occupied and typically also for how long it will be occupied. In FIG. 4A, shading of certain frames indicates that transmission of these frames could be omitted. For example, if AP2 decides not to participate in the cooperation, it may refrain from sending the RTR frame, and would subsequently also not send the downlink transmission. Further, usage of the RTS/CTS frame exchange and/or sending of the acknowledgement can be optional. The acknowledgement sent by the STA may separately indicate the reception status of the two downlink transmissions, i.e., indicate the successful reception per RU or group of subcarriers. For example, the acknowledgement could be sent on the same frequency resources on which the STA received the downlink transmission(s).

The RTS frame or some other signaling frame between AP1 and its associated STA may be used to configure the sending of the acknowledgement by the STA, e.g., by indicating whether the acknowledgement is to be sent separately for each of the different frequency resources allocated to AP1 and AP2, or by indicating on which of these frequency resources the acknowledgement is to be sent. Further, such signaling between AP1 and its associated STA may inform the STA about the utilized MCS of the downlink transmissions, in particular if the utilized MCS differs between AP1 and AP2.

Also in the example of FIG. 4B, it is assumed that AP1 gains access to the wireless channel and reserves a TXOP which it intends to use for coordinated downlink transmissions from AP1 and AP2 to a STA, which is associated with AP1. AP1 thus sends an ITR frame to AP2. If AP2 is willing to participate in the cooperation, AP2 sends an RTR frame to AP1. Then an RTS/CTS frame exchange is performed between AP1 and the STA. After the RTS/CTS frame exchange, both AP1 and AP2 send a downlink transmission (DL TX) carrying the same data to the STA. These downlink transmissions are performed subsequently, using different time slots within the TXOP. Upon successfully receiving at least one of these redundant downlink transmissions, the STA sends an acknowledgement (ACK) to confirm successful reception. The acknowledgement may be sent to AP1 and/or to AP2.

The ITR frame may include an indication of a selected multi-AP coordination mode, e.g., an indication of coordination by TDMA. Further, the ITR frame may indicate a resource allocation for AP1 and AP2, e.g., in terms of one or more time slots allocated to AP1 and one or more time slots allocated to AP2. Further, the ITR frame may indicate a length of the intended downlink transmissions, e.g., terms of a length of PPDU (Physical Packet Data Unit) to be transmitted.

The RTS frame from AP1 may inform the STA that the upcoming downlink transmissions includes a replica of the same signal in different time slots. Here, it is noted that the STA typically does not need to be informed that the replicas come from different APs. Further, the ITR frame, the RTR frame, the RTS frame, and the CTS frame may be used to protect the wireless channel from interference, by indicating to other devices that the wireless channel is occupied and typically also for how long it will be occupied. Also in FIG. 4B, shading of certain frames indicates that transmission of these frames could be omitted. For example, if AP2 decides not to participate in the cooperation, it may refrain from sending the RTR frame, and would subsequently also not send the downlink transmission. Further, usage of the RTS/CTS frame exchange and/or sending of the acknowledgement can be optional. The acknowledgement sent by the STA may separately indicate the reception status of the two downlink transmissions, i.e., indicate the successful reception per time slot. For example, the acknowledgement could be sent immediately, e.g., an SIFS (Short Interframe Space) after the STA received the respective downlink transmission. Further, in some scenarios, if the downlink transmission performed first, in the illustrated example that from AP1, is successful and this is confirmed by the acknowledgement from the STA, this acknowledgement could also be decoded by AP2, and in response AP2 could refrain from sending its downlink transmission to the STA.

The RTS frame or some other signaling frame between AP1 and its associated STA may be used to configure the sending of the acknowledgement by the STA, e.g., by indicating whether the acknowledgement is to be sent separately for each of the time slots allocated to AP1 and AP2, or by indicating when the acknowledgement is to be sent. Further, such signaling between AP1 and its associated STA may inform the STA about the utilized MCS of the downlink transmissions, in particular if the utilized MCS differs between AP1 and AP2.

In the procedures of FIG. 4A or 4B, the APs may learn from the acknowledgement received from the STA which of the downlink transmissions to the STA was successful. This information may be used for various purposes, such as link adaptation for future downlink transmissions to the STA. In the case of link adaption for uplink transmission from the STA, the STA may be informed by additional signaling which of the downlink transmissions shall be used as input for link adaptation. As mentioned above, such additional signaling from the connected AP could for example be included in the RTS frame or some additional signaling frame transmitted before the downlink transmissions to the STA.

It is further noted that while the above examples focused on cases where the coordination involves that the connected AP and one or more non-connected APs redundantly send the same data to the STA associated with the connected AP, the coordination may in some cases also involve deciding which of the connected AP and the non-connected AP(s) shall send the data to the STA, e.g., based on load balancing considerations or based on individual channel conditions between the STA and the different APs. For example, in some cases the coordination could involve a decision that only the connected AP shall send the data or a decision that only one of the non-connected APs shall send the data.

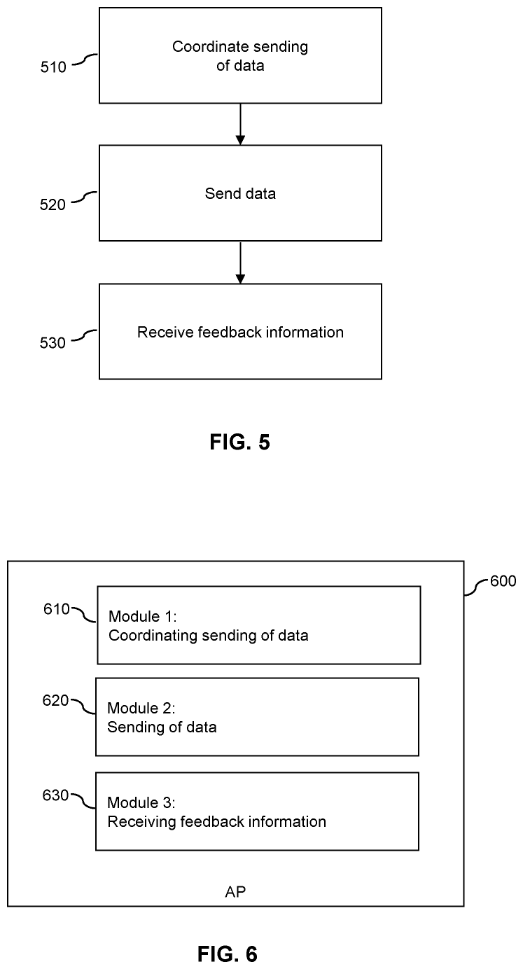

FIG. 5 shows a flowchart for illustrating a method of controlling wireless transmissions in a wireless communication system, which may be utilized for implementing the illustrated concepts. The method of FIG. 5 may be used for implementing the illustrated concepts in an AP of a wireless communication system, e.g., one of the above-mentioned APs 10. The AP may correspond to the connected AP of the above examples. The wireless communication system may be based on a wireless local area network, WLAN, technology, e.g., according to the IEEE 802.11 standards family.

If a processor-based implementation of the AP is used, at least some of the steps of the method of FIG. 5 may be performed and/or controlled by one or more processors of the AP. Such AP may also include a memory storing program code for implementing at least some of the below described functionalities or steps of the method of FIG. 5.

At step 510, the AP coordinates sending of data on a wireless link. The wireless link is established between the AP and the wireless device. The wireless device may be a non-AP STA associated with the AP. The AP may obtain the data from a data network, e.g., a local area network (LAN) or from the Internet. The data may for example relate to an application running on the wireless device. In some cases, the data may also be generated locally at the AP, e.g., as a response to an uplink transmission from the wireless device.

In particular, the AP coordinates the sending of the data by at least one of: sending of the data by a first wireless transmission performed by the AP and sending of the data by a second wireless transmission performed on behalf of the AP by a further AP of the wireless communication system. The further AP may correspond to one of the non-connected APs of the above examples. Also the further AP may correspond to one of the above-mentioned APs 10. In some cases, the coordination may cause the data to be sent in a redundant manner, by both the first wireless transmission and the second wireless transmission. In other cases, the coordination may cause the data to be sent by either the first wireless transmission or the second wireless transmission, e.g., depending on channel conditions between the AP and the wireless device and channel conditions between the further AP and the wireless device. The coordination may be based on signaling between the AP and the further AP and/or on signaling between the AP and the wireless device. Examples of such signaling are illustrated in FIGS. 4A and 4B. The coordination may also involve that the AP provides the data to the further AP.

In some scenarios, the AP may coordinate the sending of the data by at least one of the first wireless transmission and multiple second wireless transmissions performed on behalf of the AP by multiple further APs of the wireless communication system. An example of a corresponding scenario is explained in connection with FIG. 3.

In some scenarios, the first wireless transmission may be based on a first MCS, while the second wireless transmission is based on a second MCS which is different from the first MCS.

In some scenarios, the first wireless transmission and the second wireless transmission may be coordinated by DCM or DCM+DUP.

In some scenarios, the first wireless transmission and the second wireless transmission may be coordinated by OFDMA. In such scenarios, the first wireless transmission can be on a first bandwidth portion, while the second wireless transmission is on a second bandwidth portion which can have a different size than the first bandwidth portion.

In some scenarios, the first wireless transmission and the second wireless transmission may be coordinated by TDMA. In such scenarios, the first wireless transmission can be in a first time slot, while the second wireless transmission is in a second time slot which has a different size than the first time slot.

The coordination may be based on a wire-based link between the AP and the further AP. FIG. 2A illustrates a corresponding example. Further, the coordination may be based on a wireless link between the AP and the further AP. FIG. 2B illustrates a corresponding example. In some scenarios, the coordination may be based on interaction with a network controller coupled to the AP and the further AP, e.g., as illustrated in FIG. 2A.

In some scenarios, the AP may also coordinate sending of further data on a further wireless link established between the further AP and a further wireless device. The further wireless device may be a non-AP STA associated to the further AP. For the further wireless device, the AP may correspond to a non-connected AP as explained above. On the further wireless link, the AP may coordinate the sending of the further data by at least one of: sending of the further data by a third wireless transmission performed by the further AP, and sending of the further data by a fourth wireless transmission performed on behalf of the further AP by the AP.

The AP may select the further AP based on a load of the further AP and/or based on a load of the AP. Further, the AP may select the further AP based on one or more measurements reported by the wireless device.

At step 520, the AP may send the data in the first wireless transmission. However, as mentioned above, in some cases sending of the data in the first wireless transmission could be omitted and the data be sent only in the second wireless transmission performed by the further AP.

At step 530, the AP may receive feedback information from the wireless device in response to the first wireless transmission and/or in response to the second wireless transmission. The feedback information may indicate whether the data was successfully received by the wireless device, such as explained for the above-mentioned acknowledgements. In some cases, the AP may forward the received feedback information to the further AP. In other cases, the AP may receive the feedback information via the further AP. The feedback information may in some cases separately indicate whether the data was successfully received through the first wireless transmission or through the second wireless transmission. Based on the feedback information, the AP may control connectivity of the wireless device to the wireless communication system, e.g., by performing link adaptation or by triggering a reassociation of the wireless device to another AP.

FIG. 6 shows a block diagram for illustrating functionalities of an AP 600 which operates according to the method of FIG. 5. The AP 600 may correspond to one of the above-mentioned APs 10. As illustrated, the AP 600 may be provided with a module 610 configured to coordinate sending of data on a wireless link, such as explained in connection with step 510. Further, the AP 600 may be provided with a module 620 configured to send the data on the wireless link, such as explained in connection with step 520. Further, the AP 600 may be provided with a module 630 configured to receive feedback information, such as explained in connection with step 530.

It is noted that the AP 600 may include further modules for implementing other functionalities, such as known functionalities of an AP in an IEEE 802.11 technology. Further, it is noted that the modules of the AP 600 do not necessarily represent a hardware structure of the wireless AP 600, but may also correspond to functional elements, e.g., implemented by hardware, software, or a combination thereof.

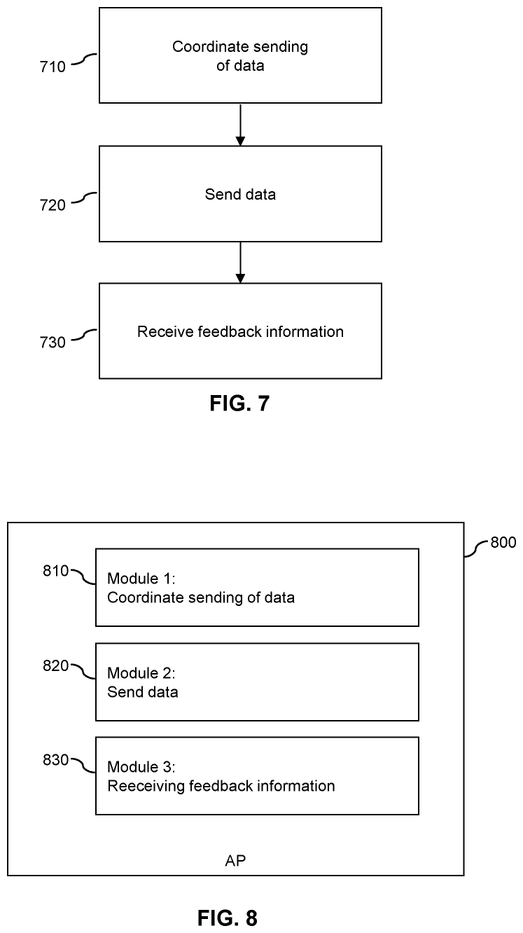

FIG. 7 shows a flowchart for illustrating a method of controlling wireless transmissions in a wireless communication system, which may be utilized for implementing the illustrated concepts. The method of FIG. 7 may be used for implementing the illustrated concepts in an AP of a wireless communication system, e.g., one of the above-mentioned APs 10. The AP may correspond to the non-connected AP of the above examples. The wireless communication system may be based on a wireless local area network, WLAN, technology, e.g., according to the IEEE 802.11 standards family.

If a processor-based implementation of the AP is used, at least some of the steps of the method of FIG. 7 may be performed and/or controlled by one or more processors of the AP. Such AP may also include a memory storing program code for implementing at least some of the below described functionalities or steps of the method of FIG. 7.

At step 710, the AP coordinates sending of data on a wireless link. The wireless link is established between wireless device and a further AP of the wireless communication system. The wireless device may be a non-AP STA associated with the further AP. The AP may obtain the data from the further AP. The data may for example relate to an application running on the wireless device.

In particular, the AP coordinates the sending of the data by at least one of: sending of the data by a first wireless transmission performed by the further AP and sending of the data by a second wireless transmission performed on behalf of the further AP by the AP. The further AP may correspond to the connected AP of the above examples. Also the further AP may correspond to one of the above-mentioned APs 10. In some cases, the coordination may cause the data to be sent in a redundant manner, by both the first wireless transmission and the second wireless transmission. In other cases, the coordination may cause the data to be sent by either the first wireless transmission or the second wireless transmission, e.g., depending on channel conditions between the AP and the wireless device and channel conditions between the further AP and the wireless device. The coordination may be based on signaling between the AP and the further AP and/or on signaling between the further AP and the wireless device. Examples of such signaling are illustrated in FIGS. 4A and 4B. The coordination may also involve that the further AP provides the data to the AP.

In some scenarios, the AP may coordinate the sending of the data by at least one of the first wireless transmission and multiple second wireless transmissions performed on behalf of the further AP by the AP and at least one additional further AP of the wireless communication system. An example of a corresponding scenario is explained in connection with FIG. 3.

In some scenarios, the first wireless transmission may be based on a first MCS, while the second wireless transmission is based on a second MCS which is different from the first MCS.

In some scenarios, the first wireless transmission and the second wireless transmission may be coordinated by DCM or DCM+DUP.

In some scenarios, the first wireless transmission and the second wireless transmission may be coordinated by OFDMA. In such scenarios, the first wireless transmission can be on a first bandwidth portion, while the second wireless transmission is on a second bandwidth portion which has a different size than the first bandwidth portion.

In some scenarios, the first wireless transmission and the second wireless transmission may be coordinated by TDMA. In such scenarios, the first wireless transmission can be in a first time slot, while the second wireless transmission is in a second time slot which has a different size than the first time slot.

The coordination may be based on a wire-based link between the AP and the further AP. FIG. 2A illustrates a corresponding example. Further, the coordination may be based on a wireless link between the AP and the further AP. FIG. 2B illustrates a corresponding example. In some scenarios, the coordination may be based on interaction with a network controller coupled to the AP and the further AP, e.g., as illustrated in FIG. 2A.

In some scenarios, the AP may also coordinate sending of further data on a further wireless link established between the AP and a further wireless device. The further wireless device may be a non-AP STA associated to the AP. For the further wireless device, the AP may correspond to the connected AP as explained above. On the further wireless link, the AP may coordinate the sending of the further data by at least one of: sending of the further data by a third wireless transmission performed by the AP, and sending of the further data by a fourth wireless transmission performed on behalf of the AP by the further AP.

The AP may select the further AP based on a load of the further AP and/or based on a load of the AP. Further, the AP may select the further AP based on one or more measurements reported by the wireless device.

At step 720, the AP may send the data in the second wireless transmission. However, as mentioned above, in some cases sending of the data in the second wireless transmission could be omitted and the data be sent only in the first wireless transmission performed by the further AP.

At step 730, the AP may receive feedback information from the wireless device in response to the first wireless transmission and/or in response to the second wireless transmission. The feedback information may indicate whether the data was successfully received by the wireless device, such as explained for the above-mentioned acknowledgements. In some cases, the AP may forward the received feedback information to the further AP. In other cases, the AP may receive the feedback information via the further AP. The feedback information may in some cases separately indicate whether the data was successfully received through the first wireless transmission or through the second wireless transmission.

FIG. 8 shows a block diagram for illustrating functionalities of an AP 800 which operates according to the method of FIG. 7. The AP 800 may correspond to one of the above-mentioned APs 10. As illustrated, the AP 800 may be provided with a module 810 configured to coordinate sending of data on a wireless link, such as explained in connection with step 710. Further, the AP 800 may be provided with a module 820 configured to send the data on the wireless link, such as explained in connection with step 720. Further, the AP 800 may be provided with a module 830 configured to receive feedback information, such as explained in connection with step 730.

It is noted that the AP 800 may include further modules for implementing other functionalities, such as known functionalities of an AP in an IEEE 802.11 technology. Further, it is noted that the modules of the AP 800 do not necessarily represent a hardware structure of the wireless AP 800, but may also correspond to functional elements, e.g., implemented by hardware, software, or a combination thereof.

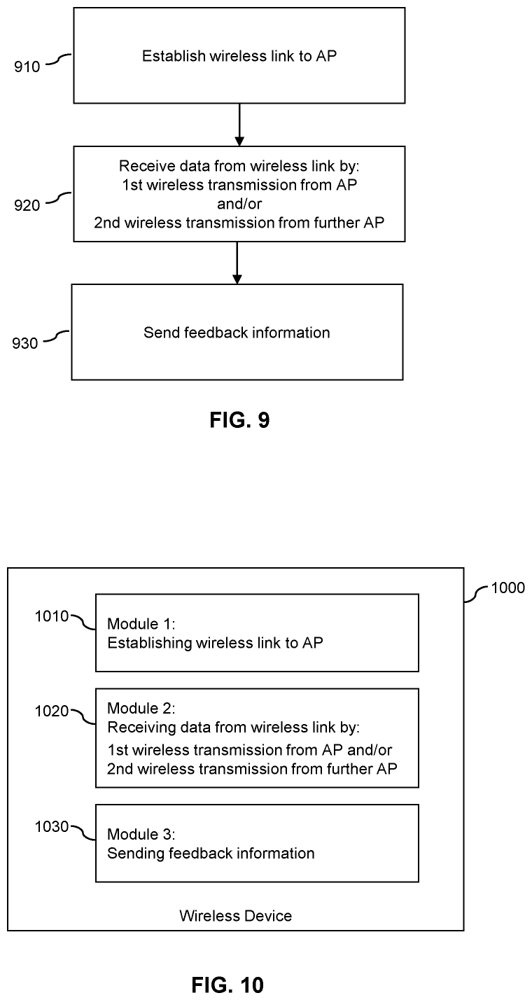

FIG. 9 shows a flowchart for illustrating a method, which may be utilized for implementing the illustrated concepts. The method of FIG. 9 may be used for implementing the illustrated concepts in a wireless device, such as one of the above-mentioned stations 11. The wireless communication system may be based on a wireless local area network, WLAN, technology, e.g., according to the IEEE 802.11 standards family. The wireless device may correspond to a non-AP STA.

If a processor-based implementation of the wireless device is used, at least some of the steps of the method of FIG. 9 may be performed and/or controlled by one or more processors of the wireless device. Such wireless device may also include a memory storing program code for implementing at least some of the below described functionalities or steps of the method of FIG. 9.

At step 910, the wireless device establishes a wireless link to an AP of the wireless communication system, e.g., one of the above-mentioned APs 10. The AP may correspond to the connected AP of the above examples. The wireless device may be a non-AP STA which is associated to the AP. Step 910 may thus involve that the wireless device associates to the AP

At step 920, the wireless device receives data from the wireless link. This is accomplished by at least one of: receiving of the data by a first wireless transmission performed by the AP and receiving of the data by a second wireless transmission performed on behalf of the AP by a further AP of the wireless communication system, e.g., one of the above-mentioned APs 10, corresponding to a non-connected AP of the above examples. The first wireless transmission and the second wireless transmission are coordinated on the wireless link. In some cases, the coordination may cause the data to be sent in a redundant manner, by both the first wireless transmission and the second wireless transmission. In other cases, the coordination may cause the data to be sent by either the first wireless transmission or the second wireless transmission, e.g., depending on channel conditions between the AP and the wireless device and channel conditions between the further AP and the wireless device. The coordination may be based on signaling between the AP and the further AP and/or on signaling between the AP and the wireless device. Examples of such signaling are illustrated in FIGS. 4A and 4B. The coordination may also involve that the AP provides the data to the further AP.

In some scenarios, the first wireless transmission may be coordinated with multiple second wireless transmissions performed on behalf of the AP by multiple further APs. An example of a corresponding scenario is explained in connection with FIG. 3.

In some scenarios, the first wireless transmission may be based on a first MCS, while the second wireless transmission is based on a second MCS which is different from the first MCS.

In some scenarios, the first wireless transmission and the second wireless transmission may be coordinated by DCM or DCM+DUP.

In some scenarios, the first wireless transmission and the second wireless transmission may be coordinated by OFDMA. In such scenarios, the first wireless transmission can be on a first bandwidth portion, while the second wireless transmission is on a second bandwidth portion which has a different size than the first bandwidth portion.

In some scenarios, the first wireless transmission and the second wireless transmission may be coordinated by TDMA. In such scenarios, the first wireless transmission can be in a first time slot, while the second wireless transmission is in a second time slot which has a different size than the first time slot.

At step 930, in response to receiving the data at step 920, the wireless device may send feedback information to at least one of the AP and the further AP. The feedback information may indicate whether the data was successfully received by the wireless device, such as explained for the above-mentioned acknowledgements. In some scenarios, the wireless device may send feedback to both the AP and the further AP. The feedback information may in some cases separately indicate whether the data was successfully received through the first wireless transmission or through the second wireless transmission.

FIG. 10 shows a block diagram for illustrating functionalities of a wireless device 1000 which operates according to the method of FIG. 9. The wireless device 1000 may correspond to one of the above-mentioned stations 11. As illustrated, the wireless device 1000 may be provided with a module 1010 configured to establish a wireless link to an AP, such as explained in connection with step 910. Further, the wireless device 1000 may be provided with a module 1020 configured to receive data from the wireless link, such as explained in connection with step 920. Further, the wireless device 1000 may be provided with a module 1030 configured to send feedback information, such as explained in connection with step 930.

It is noted that the wireless device 1000 may include further modules for implementing other functionalities, such as known functionalities of a non-AP STA in an IEEE 802.11 technology. Further, it is noted that the modules of the wireless device 1000 do not necessarily represent a hardware structure of the wireless device 1000, but may also correspond to functional elements, e.g., implemented by hardware, software, or a combination thereof.

It is noted that the methods of FIGS. 5, 7, and 9 could also be combined. For example, the methods of FIGS. 5 and 7 could be combined in a system which includes a connected AP operating according to the method of FIG. 5 and at least one non-connected AP operating according to the method of FIG. 7. In that case, the further AP in the method of FIG. 5 would correspond to the AP in the method of FIG. 7, and the further AP in the method of FIG. 7 would correspond to the AP in the method of FIG. 5. Further, such system could also include a wireless device operating according to the method of FIG. 9. Further, it is noted that the same AP could operate according to the method of FIG. 5, as a connected AP for one or more wireless devices, and according to the method of FIG. 9, as a non-connected AP for one or more other wireless devices.

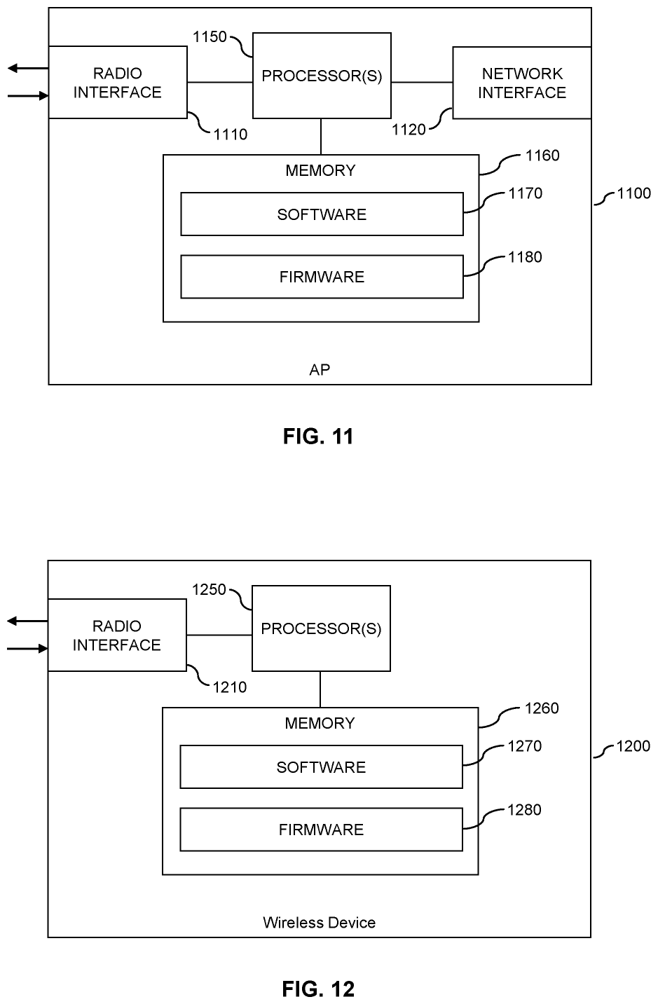

FIG. 11 illustrates a processor-based implementation of an AP 1100. The structures as illustrated in FIG. 11 may be used for implementing the above-described concepts. The AP 1100 may for example correspond to one of above-mentioned APs 10.

As illustrated, the AP 1100 includes a radio interface 1110. The radio interface 1110 may for example be based on a WLAN technology, e.g., according to an IEEE 802.11 family standard. However, other wireless technologies could be supported as well, e.g., the LTE technology or the NR technology. Further, the AP 1100 is provided with a network interface 1120 for connecting to a data network, e.g., using a wire-based connection.

Further, the AP 1100 may include one or more processors 1150 coupled to the interfaces 1110, 1120, and a memory 1160 coupled to the processor(s) 1150. By way of example, the interfaces 1110, 1120, the processor(s) 1150, and the memory 1160 could be coupled by one or more internal bus systems of the AP 1100. The memory 1160 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1160 may include software 1170 and/or firmware 1180. The memory 1160 may include suitably configured program code to be executed by the processor(s) 1150 so as to implement the above-described functionalities for controlling wireless transmissions, such as explained in connection with the methods of FIG. 5 or 7.

It is to be understood that the structures as illustrated in FIG. 11 are merely schematic and that the AP 1100 may actually include further components which, for the sake of clarity, have not been illustrated, e.g., further interfaces or further processors. Also, it is to be understood that the memory 1160 may include further program code for implementing known functionalities of an AP in an IEEE 802.11 technology. According to some embodiments, also a computer program may be provided for implementing functionalities of the AP 1100, e.g., in the form of a physical medium storing the program code and/or other data to be stored in the memory 1160 or by making the program code available for download or by streaming.

FIG. 12 illustrates a processor-based implementation of a wireless device 1200. The structures as illustrated in FIG. 12 may be used for implementing the above-described concepts. The wireless device 1200 may for example correspond to one of above-mentioned stations 11. The wireless device 1200 may correspond to a non-AP STA.

As illustrated, the wireless device 1200 includes a radio interface 1210. The radio interface 1210 may for example be based on a WLAN technology, e.g., according to an IEEE 802.11 family standard. However, other wireless technologies could be supported as well, e.g., the LTE technology or the NR technology.

Further, the wireless device 1200 may include one or more processors 1250 coupled to the interface 1210 and a memory 1260 coupled to the processor(s) 1250. By way of example, the interface 1210, the processor(s) 1250, and the memory 1260 could be coupled by one or more internal bus systems of the wireless device 1200. The memory 1260 may include a ROM, e.g., a flash ROM, a RAM, e.g., a DRAM or SRAM, a mass storage, e.g., a hard disk or solid state disk, or the like. As illustrated, the memory 1260 may include software 1270 and/or firmware 1280. The memory 1260 may include suitably configured program code to be executed by the processor(s) 1250 so as to implement the above-described functionalities for controlling wireless transmissions, such as explained in connection with the method of FIG. 9.

It is to be understood that the structures as illustrated in FIG. 12 are merely schematic and that the wireless device 1200 may actually include further components which, for the sake of clarity, have not been illustrated, e.g., further interfaces or further processors. Also, it is to be understood that the memory 1260 may include further program code for implementing known functionalities of a non-AP STA in an IEEE 802.11 technology. According to some embodiments, also a computer program may be provided for implementing functionalities of the wireless device 1200, e.g., in the form of a physical medium storing the program code and/or other data to be stored in the memory 1260 or by making the program code available for download or by streaming.

As can be seen, the concepts as described above may be used for efficiently managing transmission of data by multiple APs. In particular, wireless transmissions of the data may be coordinated on the same link, so that a certain wireless device can receive data from multiple APs, while being associated to only one of these APs. The probability of successful reception of data may be improved, which helps to increase reliability and reduce a need for retransmissions.

It is to be understood that the examples and embodiments as explained above are merely illustrative and susceptible to various modifications. For example, the illustrated concepts may be applied in connection with various kinds of wireless technologies, without limitation to WLAN technologies. Further, the concepts may be also be applied with respect to any number of APs cooperating on the same wireless link. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-57. (canceled)

58. A method of controlling wireless transmissions in a wireless communication system, the method comprising:
an access point of the wireless communication system coordinating sending of data on a wireless link, established between the access point and a wireless device, by at least one of:
a first wireless transmission performed by the access point, and
a second wireless transmission performed on behalf of the access point by a further access point of the wireless communication system;
wherein the first wireless transmission and the second wireless transmission carry the same data in a redundant manner.

59. The method of claim 58, comprising:
in response to the first wireless transmission and/or in response to the second wireless transmission, the access point receiving feedback information from the wireless device and forwarding the feedback information to the further access point.

60. The method of claim 58,
wherein the access point coordinates the sending of the data by at least one of the first wireless transmission and multiple second wireless transmissions performed on behalf of the access point by multiple further access points of the wireless communication system.

61. The method of claim 58,
wherein the first wireless transmission and the second wireless transmission are coordinated by Dual Carrier Modulation (DCM).

62. The method of claim 58,
wherein the first wireless transmission is on a first bandwidth portion and the second wireless transmission is on a second bandwidth portion which has a different size than the first bandwidth portion.

63. The method of claim 58,
wherein the first wireless transmission and the second wireless transmission are coordinated based on Time Division Multiple Access (TDMA), wherein the first wireless transmission is in a first time slot and the second wireless transmission is in a second time slot which has a different size than the first time slot.

64. The method of claim 58,
wherein the coordination comprises deciding whether to perform either the first wireless transmission or the second wireless transmission.

65. The method of claim 58,
wherein the coordination is based on interaction with a network controller coupled to the access point and the further access point.

66. The method of claim 58, comprising:
the access point coordinating sending of further data on a further wireless link, established between the further access point and a further wireless device, by at least one of:
a third wireless transmission performed by the further access point, and
a fourth wireless transmission performed on behalf of the further access point by the access point.

67. The method of claim 58, comprising:
the access point selecting the further access point based on a load of the further access point or based on one or more measurements reported by the wireless device.

68. A method of controlling wireless transmissions in a wireless communication system, the method comprising:
an access point of the wireless communication system coordinating sending of data on a wireless link, established between a further access point of the wireless communication system and a wireless device, by at least one of:
a first wireless transmission performed by the further access point, and
a second wireless transmission performed on behalf of the further access point by the access point;
wherein the first wireless transmission and the second wireless transmission carry the same data in a redundant manner.

69. A method of controlling wireless transmissions in a wireless communication system, the method comprising:
a wireless device establishing a wireless link to an access point of the wireless communication system; and
the wireless device receiving data from the wireless link by least one of:
a first wireless transmission performed by the access point, and a second wireless transmission performed on behalf of the access point by a further access point of the wireless communication system,
wherein the first wireless transmission and the second wireless transmission carry the same data in a redundant manner, and
wherein the first wireless transmission and the second wireless transmission are coordinated on the wireless link.

70. The method of claim 69, comprising:
in response to the first wireless transmission and/or the second wireless transmission, the wireless device sending feedback information to at least one of the access point and the further access point.

71. The method of claim 69, comprising:
in response to the first wireless transmission and/or the second wireless transmission, the wireless device sending feedback information to both the access point and the further access point.

72. The method of claim 69,
wherein the first wireless transmission is coordinated with multiple second wireless transmissions performed on behalf of the access point by multiple further access points of the wireless communication system.

73. The method of claim 69,
wherein the first wireless transmission is based on a first modulation and coding scheme (MCS) and the second wireless transmission is based on a second MCS which is different from the first MCS.

74. The method of claim 69, wherein the first wireless transmission and the second wireless transmission are coordinated based on DCM.

75. The method of claim 69, wherein the first wireless transmission and the second wireless transmission are coordinated based on OFDMA on the wireless channel, and wherein the first wireless transmission is on a first bandwidth portion and the redundant wireless transmission is on a second bandwidth portion which has a different size than the first bandwidth portion.

76. The method of claim 69, wherein the first wireless transmission and the second wireless transmission are coordinated by TDMA, and wherein the first wireless transmission is in a first time slot and the second wireless transmission is in a second time slot which has a different size than the first time slot.

77. An access point for a wireless communication system, the access point comprising:
at least one processor, and
a memory containing program code executable by the at least one processor, whereby the processor and program code are configured so that execution of the program code by the at least one processor causes the access point to:
coordinate sending of data on a wireless link, established between the wireless device and the access point, by at least one of:
a first wireless transmission performed by the access point, and
a second wireless transmission performed on behalf of the access point by a further access point of the wireless communication system,
wherein the first wireless transmission and the second wireless transmission carry the same data in a redundant manner.
